(19) United States
(12) Patent Application Publication
(10) Pub. No.: US 2006/0156463 A1
(43) Pub. Date: Jul. 20, 2006

(54) Washing nozzle and toilet device using the same

(76) Inventors: Tomoaki Kitano, Nara (JP); Yasuhiro Kawamoto, Osaka (JP); Tomoko Ishida, Nara (JP); Ryoichi Koga, Nara (JP); Tomio Arikawa, Nara (JP); Koji Yoshimoto, Nara (JP); Hiroaki Fujii, Nara (JP); Shinichi Maruyama, Nara (JP)

Correspondence Address: WENDEROTH, LIND & PONACK L.L.P., 2033 K. STREET, NW, SUITE 800, WASHINGTON, DC, 20006, US

(21) Appl. No.: 10/547,465

(22) PCT Filed: Mar. 12, 2004
(86) PCT No.: PCT/JP04/03322

§ 371 Date: Aug. 30, 2005

(30) Foreign Application Priority Data
Mar. 20, 2003 (JP) 2003-078030
May 27, 2003 (JP) 2003-148731
May 28, 2003 (JP) 2003-150647
Oct. 24, 2003 (JP) 2003-364261
May 29, 2003 (JP) 2003-152494
Dec. 26, 2003 (JP) 2003-433132
Jan. 30, 2004 (JP) 2003-022886

(51) Int. Cl. E03D 9/08; A47K 4/00

(52) U.S. Cl. 4/420.4

(57) ABSTRACT

A washing nozzle of a toilet device has a flat part in its tip, and a jet hole for jetting washing water is provided in the flat part. The flat part and a tubular main body are monolithically joined together by a continuous face. This washing nozzle is manufactured by deep-drawing a thin sheet metal material and providing the flat part in its tip. Besides, a flow adjusting member for adjusting a flow of the washing water is internally inserted. These nozzles are stable in their jet directions, further crud is difficult to adhere thereto, and they are easy to be cleaned.

### TECHNICAL FIELD

The present invention relates to a washing nozzle used in a toilet device, which washes private parts of human body.

### BACKGROUND ART

Hitherto, a washing nozzle used in the toilet device is constituted by a resin material, and a washing nozzle tip is made as a separate component. FIG. 36 is a perspective view of a conventional washing nozzle used in the toilet device, and tip part 92 of washing nozzle (hereafter, nozzle) 91 is made as a separate component and jet hole 93 is provided thereon.

In this constitution, since the washing nozzle is constituted by plural components, a joint is exposed in a nozzle surface, so that filth is liable to clog in this joint. Further, in order to obtain jet water suitable for washing the private parts, it is necessary to make the separate component that is tip part 92 of nozzle 91 into plural layers, i.e., a complicated shape. Further, a mold is liable to generate due to physical properties of the resin material, and a contamination such as filth is difficult to be removed due to the complicated shape.

In this regard, Japanese Patent Unexamined Publication No. 2001-348940 proposes a washing nozzle in which the filth is difficult to collect by making its tip simple. FIG. 37 shows a perspective view of the conventional nozzle used in the toilet device described in the above publication. Since the whole of washing nozzle (hereafter, nozzle) 94 is simple, the filth is difficult to collect.

In this constitution, an outer surface of nozzle 94 is a simple cylindrical shape and thus the filth and the like are difficult to adhere. However, water passage 96 leading to jet hole 95 is necessary, so that the structure becomes complicated.

Further, as shown in a cross-sectional view of FIG. 38, it is also possible to constitute washing nozzle 97 by a cylindrical member and provide jet hole 98 for directly jetting the washing water in this member. In this case, if a wall thickness of the cylindrical member is thin, a rectilinear propagation property that is a jet property of the water is injured, and a jet state and a jet direction become unstable, so that the jet characteristic suitable for washing the private parts of the human body is not obtained. This is due to the facts that jet hole 98 is provided in a curved face and that a flow becomes unstable by the fact that a flow passage of washing water 99 becomes suddenly narrow just before it is jetted from jet hole 98.

Especially, like FIG. 39, if water jet holes 98 are provided while being laterally juxtaposed in order to widen a washing range, jetted washing water 99 widens in left and right, so that it is impossible to obtain an objective wash feeling. Since a softness of the wash feeling becomes necessary in a bidet washing which washes female private parts, it is necessary to jet a water flow like a shower. However, in such a constitution as mentioned above, the water flows of the washing water don't become parallel. In this regard, there is considered a method of jetting washing water 99 in parallel by making the directions of jet holes 98 mutually parallel, not perpendicular to a tangential plane of the peripheral curved face of nozzle 97. However, this method is difficult to be realized in a case where nozzle 97 is formed by a deep drawing of a metal in order to inexpensively manufacture nozzle 97 and make it possible also to clean it by applying a detergent or high temperature water.

### SUMMARY OF THE INVENTION

A washing nozzle of the present invention in a toilet device has a flat part in its tip, and a water jet hole of the washing water is provided in the flat part. The flat part and a bottomed tubular main body are monolithically joined together by a continuous face. Alternatively, a washing nozzle of the present invention is provided with a flow adjusting member for adjusting the flow of the washing water in its main body. These nozzles are produced by deep-drawing a thin sheet metal material. A toilet device of the present invention has a toilet device main body mounted on a toilet bowl, and the washing nozzle of any of the above-mentioned constitutions provided in the toilet device main body.

### BRIEF DESCRIPTION OF THE DRAWINGS

FIG. 1A is a sectional view of a washing nozzle of a toilet device according to an exemplary embodiment of the present invention in a state where the washing nozzle is accommodated in a cylinder pipe.

FIG. 1B is a sectional view of the washing nozzle of FIG. 1 in a state where the washing nozzle is moved to a washing position.

FIG. 2 is a perspective view of the washing nozzle shown in FIG. 1.

FIG. 3A is an external appearance perspective view of the toilet device in the exemplary embodiment of the present invention.

FIG. 3B is a sectional view of the toilet device shown in FIG. 3A.

FIG. 4 is a longitudinal-sectional view of the washing nozzle show in FIG. 2.

FIG. 5 is a cross-sectional view of the washing nozzle shown in FIG. 2.

FIG. 6 is a perspective view of another washing nozzle in the exemplary embodiment according to the present invention.

FIG. 7 is a perspective view of a still other washing nozzle according to the exemplary embodiment of the present invention.

FIG. 8A and FIG. 8B are perspective views when cleaning the washing nozzle according to the exemplary embodiment of the present invention.

FIG. 9A is a top view of a still other washing nozzle according to the exemplary embodiment of the present invention.

FIG. 9B is a cross-sectional view of the washing nozzle show in FIG. 9A.

FIG. 10 is a longitudinal-sectional view of a still other washing nozzle according to the exemplary embodiment of the present invention.

FIG. 11 is a longitudinal-sectional view of a still other washing nozzle according to the exemplary embodiment of the present invention.

FIG. 12 is a longitudinal-sectional view of a still other washing nozzle according to the exemplary embodiment of the present invention.

FIG. 13 is an exploded perspective view of a still other washing nozzle according to the exemplary embodiment of the present invention.

FIG. 14 is a longitudinal-sectional view of a still other washing nozzle according to the exemplary embodiment of the present invention.

FIG. 15A and FIG. 15B are longitudinal-sectional views of still other washing nozzles according to the exemplary embodiment of the present invention.

FIG. 16 is a longitudinal-sectional view of a still other washing nozzle according to the exemplary embodiment of the present invention.

FIG. 17 is a longitudinal-sectional view of a still other washing nozzle according to the exemplary embodiment of the present invention.

FIG. 18 is a longitudinal-sectional view of a still other washing nozzle according to the exemplary embodiment of the present invention.

FIG. 19A-FIG. 19C are longitudinal-sectional views of a still other washing nozzle according to the exemplary embodiment of the present invention.

FIG. 19D is a perspective view of the washing nozzle show in FIG. 19A-FIG. 19C.

FIG. 20 is a longitudinal-sectional view of a still other washing nozzle according to the exemplary embodiment of the present invention.

FIG. 21 is a top view of the washing nozzle show in FIG. 20.

FIG. 22 is a longitudinal-sectional view of a still other washing nozzle according to the exemplary embodiment of the present invention.

FIG. 23 is a longitudinal-sectional view of a still other washing nozzle according to the exemplary embodiment of the present invention.

FIG. 24 is a longitudinal-sectional view of a still other washing nozzle according to the exemplary embodiment of the present invention.

FIG. 25 is a longitudinal-sectional view of a still other washing nozzle according to the exemplary embodiment of the present invention.

FIG. 26 is a longitudinal-sectional view of a still other washing nozzle according to the exemplary embodiment of the present invention.

FIG. 27 is a longitudinal-sectional view of a still other washing nozzle according to the exemplary embodiment of the present invention.

FIG. 28 is a longitudinal-sectional view of a still other washing nozzle according to the exemplary embodiment of the present invention.

FIG. 29 is a longitudinal-sectional view of a still other washing nozzle according to the exemplary embodiment of the present invention.

FIG. 30 is a top view of the washing nozzle show in FIG. 29.

FIG. 31 is a longitudinal-sectional view of a still other washing nozzle according to the exemplary embodiment of the present invention.

FIG. 32 is a longitudinal-sectional view of a still other washing nozzle according to the exemplary embodiment of the present invention.

FIG. 33 is a perspective view of a flow adjusting member used in a washing nozzle according to the exemplary embodiment of the present invention.

FIG. 34 is a perspective view of another flow adjusting member used in the washing nozzle according to the exemplary embodiment of the present invention.

FIG. 35 is a longitudinal-sectional view of a still other washing nozzle according to the exemplary embodiment of the present invention.

FIG. 36 is a perspective view of a conventional washing nozzle in the toilet device.

FIG. 37 is a perspective view of another conventional washing nozzle in the toilet device.

FIG. 38 and FIG. 39 are local cross-sectional views of still other conventional washing nozzles in the toilet device.

### DETAILED DESCRIPTION OF PREFERRED EMBODIMENTS

### First Exemplary Embodiment

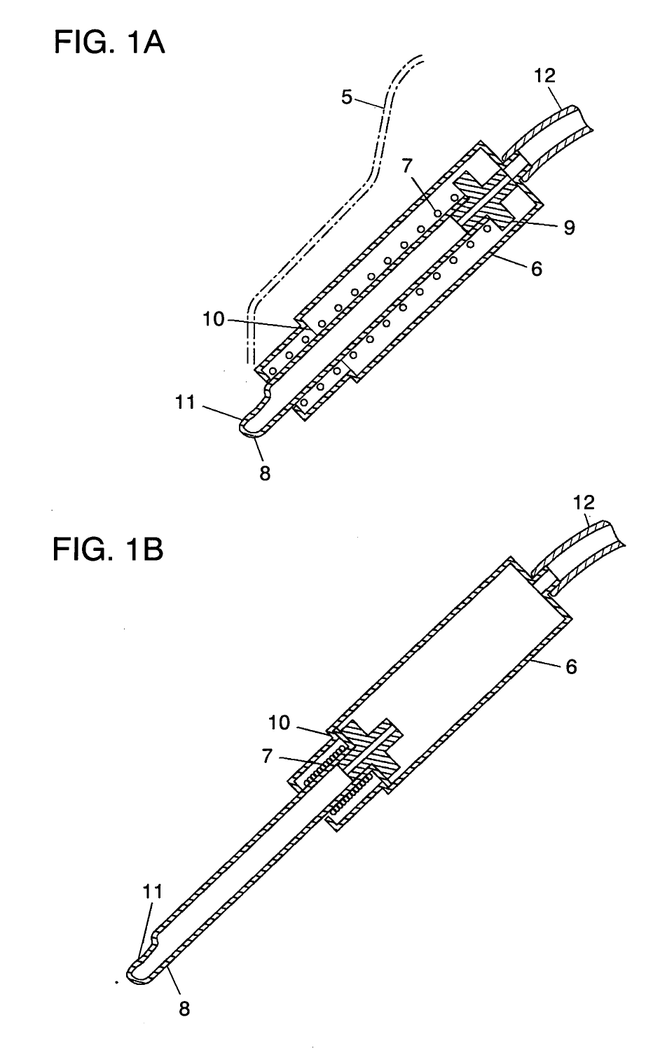

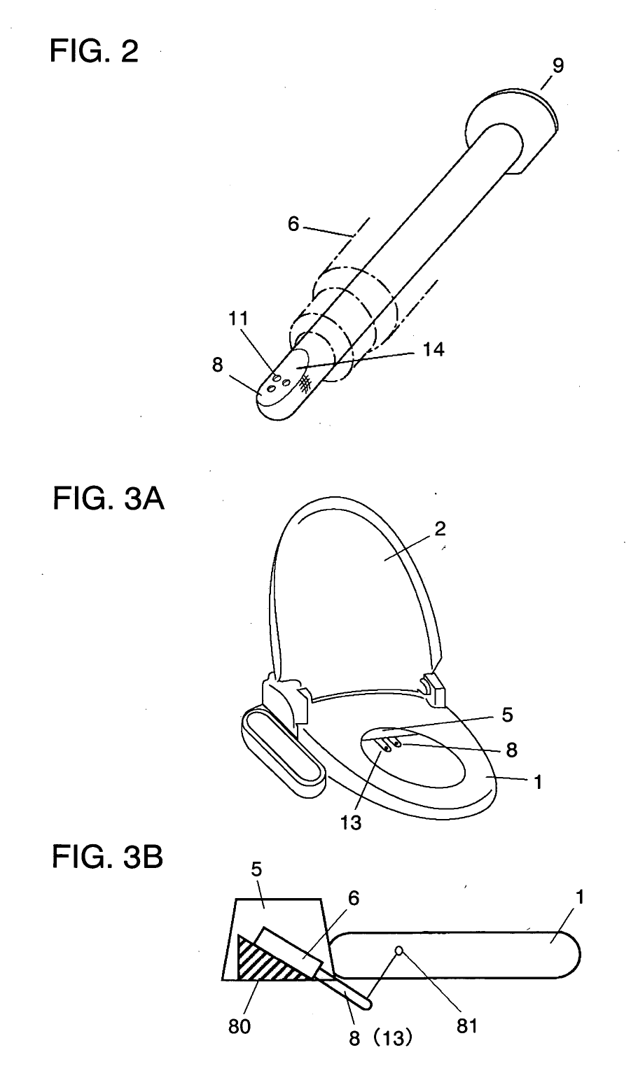

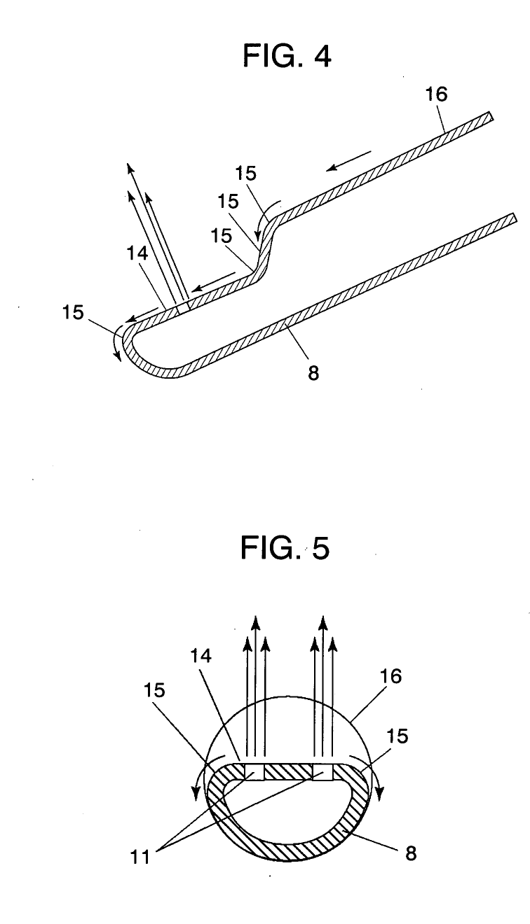

FIG. 1A and FIG. 1B show longitudinal-sectional views of a washing nozzle of a toilet device according to the exemplary embodiment of the present invention. FIG. 1A shows a state that the washing nozzle is accommodated in a cylinder pipe, and FIG. 1B shows a state that the washing nozzle is moved to a washing position. FIG. 2 is a perspective view of the washing nozzle of the toilet device, and FIG. 3A and FIG. 3B are an external appearance perspective view and a sectional view of the toilet device, respectively. FIG. 4 is a side sectional view of the washing nozzle of the toilet device, and FIG. 5 is a front sectional view of the washing nozzle of the toilet device.

As shown in FIG. 1A, washing water warmed in main body 5 is flowed to flange part 9 of washing nozzle (hereafter, nozzle) 8 accommodated into cylinder pipe 6 through hose 12. A periphery of nozzle 8 is wounded by spring 7. Nozzle 8 is driven forward by a pressure of the washing water. Thereafter, as shown in FIG. 1B, the washing water is introduced into nozzle 8, and flange part 9 butts against stepped part 10 of cylinder pipe 6 and stops. The washing water jets from jet hole 11 provided in flat part 14 of a tip of nozzle 8, thereby washing the private parts of the human body. When the washing ends and the flow stops, nozzle 8 returns backward by a biasing force of spring 7 and, nozzle 8 is accommodated again into cylinder pipe 6 as shown in FIG. 1A.

Here, after performing a deep drawing press work of a thin sheet metal material into a cylindrical shape, nozzle 8 is provided in its tip part with flat part 14 and water jet hole 11. For this reason, nozzle 8 is seamless. Further, a thickness of the metal material constituting nozzle 8 is at least 0.2 mm and at most 0.8 mm in viewpoints of lightening and strength, and at least 0.3 mm and at most 0.8 mm is more desirable.

As shown in FIG. 3A and FIG. 3B, the toilet device includes main body 5 having nozzle 8 and washing nozzle 13 which has the same function as nozzle 8 and is for exclusively washing the female private parts, toilet seat 1 which accommodates therein a heater (not shown) and is rotatably attached to main body 5, and lid 2 for covering toilet seat 1. Mount part 80 provided inside main body 5 fixes cylinder pipe 6. Nozzle 8 may directly slide with mount part 80 without providing cylinder pipe 6.

Further, as shown in FIG. 4, nozzle main body part 16 and flat part 14 in the nozzle tip are joined together by continuous face 15, in nozzle 8.

In the present constitution, the thin sheet metal material constituting nozzle 8 is stainless steel. Further, flange part 9 is formed in a D-shape by a separate component, and cylinder pipe 6 is formed in a shape corresponding to this D-shape (not shown). By this, nozzle 8 does not rotate.

In the toilet device constituted as described above, nozzle 8 is a bottomed tubular body formed by the deep drawing press work of the thin sheet metal material. Tubular nozzle main body part 16 and flat part 14 of nozzle 8 tip are joined together by continuous face 15. By this, the filth is difficult to adhere on its physical properties unlike a resin molded article. Additionally, there is not such a restriction that it cracks in dependence on a kind of the detergent at a cleaning time or it cannot be washed by the high temperature water. Further, since a sealing part in a tip like a metal pipe is unnecessary and there is no joint, the crud is difficult to adhere.

Generally, a diameter of the jet hole of the washing nozzle for private parts is about 0.8-1.2 mm. In order to form the jet hole in a certain determined direction not perpendicular to the peripheral curved face of the nozzle main body whose cross section is circular, it is necessary that a wall thickness of the nozzle main body is at least 2-3 times the diameter of the nozzle hole. For this reason, the wall thickness is generally made 2 mm or more. However, in a case where one having a size of the private parts washing nozzle is formed by the deep drawing of the metal, it is impossible to make the wall thickness 2 mm or more. On the other hand in the present embodiment, jet hole 11 is provided in flat part 14 of nozzle 8 tip as shown in FIG. 5. Thus, a jet direction property and a rectilinear propagation property of the water are stabilized, and a size and the number of the jet hole 11 are adjusted by the private parts of the human body that is a washing object, so that an optimum washing property is obtained.

Further, a feeling of cleanliness is more increased and nozzle 8 to be resist rust is obtained by making the thin sheet metal material the stainless steel. Nozzle 8 is light in weight because it is constituted by the thin sheet metal material.

Additionally, flange part 9 which drives nozzle 8 and functions as a stopper is constituted by the separate component. For this reason, it is possible to easily adjust a position and an angle of a subtle washing point by a shape of flange part 9. For example, in a case where flange part 9 is manufactured by a resin molding and the nozzle 8 by the deep drawing press work, it is expected that a complicated shape for a subtle adjustment is formed in flange part 9 and nozzle 8 is made a simple shape. The resin molding can be comparatively, inexpensively made even for the complicated shape and, on the other hand, it is unnecessary to perform the deep drawing press work of the complicated shape or the deep drawing press work whose accuracy is high. For this reason, the toilet device can be inexpensively manufactured as a whole.

In the present constitution as shown FIG. 4, flat part 14 is parallel to an advance/retreat direction of nozzle 8. As a constitution other than this, flat part 14 is caused to have an angle. If made like this, the washing water jets in a direction other than perpendicular to the advance/retreat direction of nozzle 8.

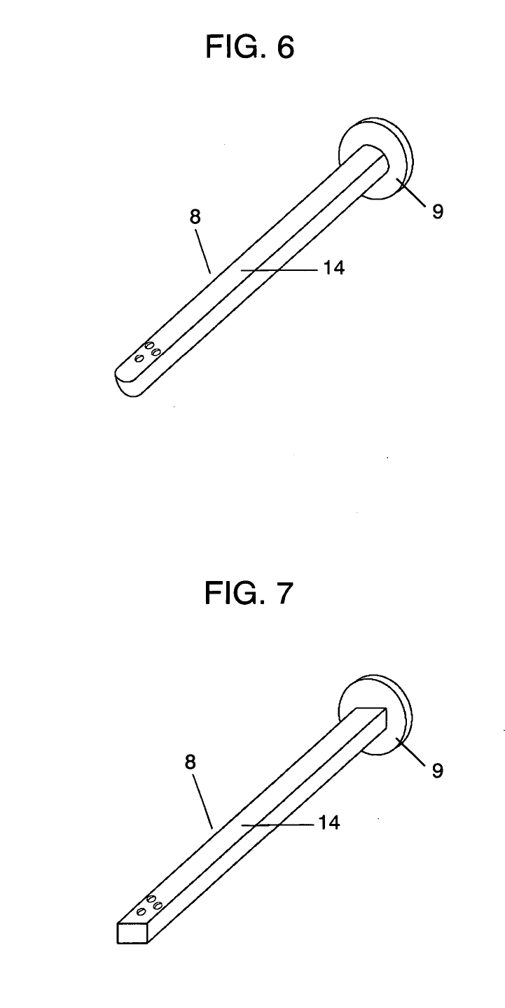

As shown in FIG. 6, after performing the deep drawing press work of the thin sheet metal material into the cylindrical shape, nozzle 8 may be provided with flat part 14 over the whole length along its longitudinal direction. Or, as shown in FIG. 7, a section may be made a polygon. In nozzle 8 constituted like these, by making a hole in the tip of cylinder pipe 9 into a shape corresponding to flat part 14, a rotation of nozzle 8 is prevented and a shape of an inside of cylinder pipe 9 can be simplified. Further, in a case of constituting like FIG. 7, a deep drawing press workability of the thin sheet metal material is good, so that it is easy to form the shape.

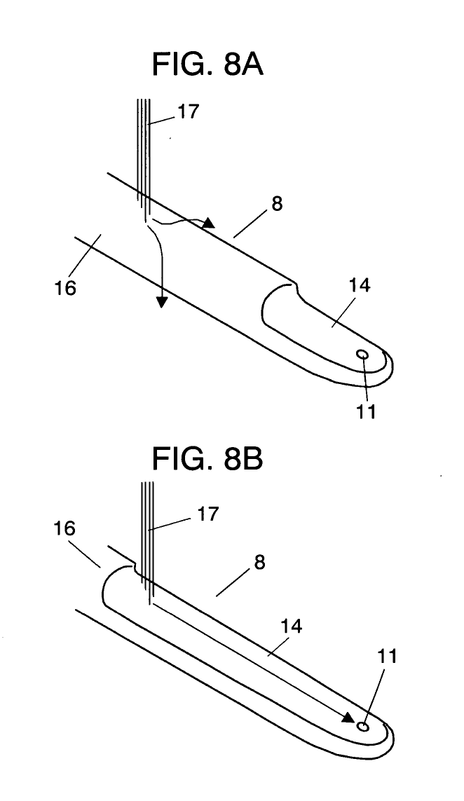

Further, since flat part 14 is provided over the whole length along the longitudinal direction of nozzle 8, the detergent or the high temperature water is difficult to flow down. It is explained about this aspect by using FIG. 8A and FIG. 8B. When nozzle 8 is incorporated into the toilet device, it is generally provided such that its tip side is a lower part. For the washing of nozzle main body part 16, the detergent or the high temperature water (washing liquid) 17 is applied to an upper face of nozzle main body part 16, excluding its tip part. In a case where flat part 14 exists only near the tip of nozzle 8 as shown in FIG. 8A, washing liquid 17 flows down along an approximately circular outer face of nozzle main body part 16. For this reason, the washing liquid hardly reaches a tip of nozzle main body part 16, especially jet hole 11.

On the other hand, flat part 14 is provided over the whole length of nozzle 8 in FIG. 8B. In this constitution, even if washing liquid 17 is applied to the upper face at any places in nozzle 8, washing liquid 17 is difficult to flow down. As shown by an arrow, it reaches the tip of nozzle 8, especially jet hole 11, and washing is certainly performed.

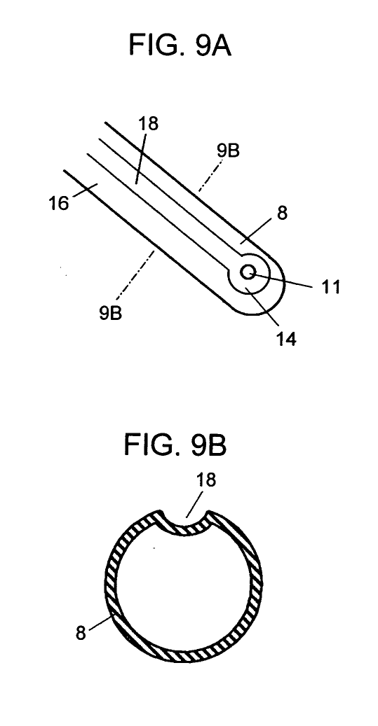

Even if nozzle 8 is constituted as shown in FIG. 9A and FIG. 9B, effects similar to the above are obtained. FIG. 9A is a perspective view of nozzle 8, and FIG. 9B a sectional view in an E-E line of FIG. 9A. In nozzle main body part 16, concave groove 18 is provided from a vicinity of a root of nozzle main body part 16 to a vicinity of jet hole 11 in the tip such that washing liquid 17 applied for washing to the upper face flows smoothly and leads to jet hole 11. That is, washing liquid 17 reaches jet hole 11 while flowing through concave groove 18.

In this constitution, the detergent or high temperature water 17 is guided by concave groove 18, and flows more smoothly than examples shown in FIG. 6, FIG. 7 and FIG. 8B. Even if concave groove 18 is slightly separated from jet hole 11, the washing liquid reaches jet hole 11 to thereby bring about a desired effect and, if concave groove 18 contacts with jet hole 11, the detergent or the high temperature water certainly reaches. A case where nozzle main body part 16 has an approximately circular sectional shape is shown in FIG. 9A. Besides, in a case where flat part 14 is possessed in the upper face over the whole region of nozzle main body part 16 in the longitudinal direction, it can be similarly performed even if concave groove 18 is provided in flat part 14.

A washing effect of jet hole 11 by concave groove 18 is effective even in a case where jet hole 11 is provided without providing flat part 14 in nozzle 8.

Jet hole 11 may be provided singly or plural jet holes 11 may be provided in dependence on a use. By providing jet holes 11 to thereby jet the washing water in parallel, nozzle 8 gives a soft wash feeling to the human body while ensuring a sufficient washing water quantity. Even if a distance between nozzle 8 and private parts of the human body changes, the private parts can be washed in a condition where water reaching area is constant. This brings about an effect especially in the bidet washing.

### Second Exemplary Embodiment

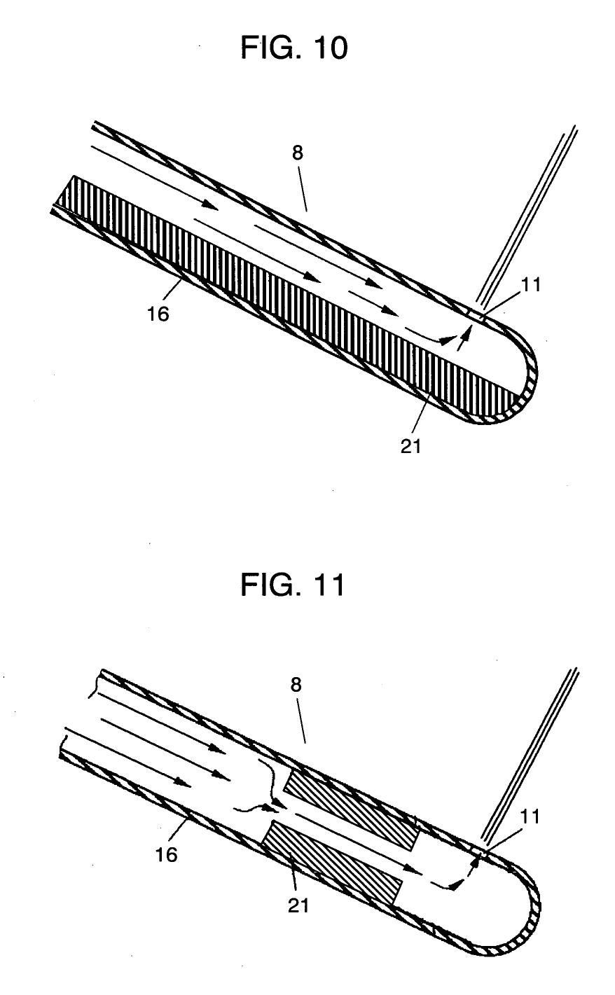

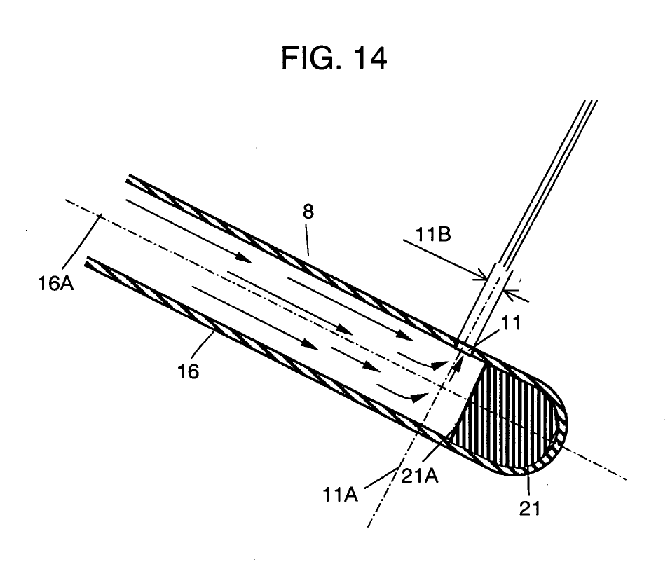

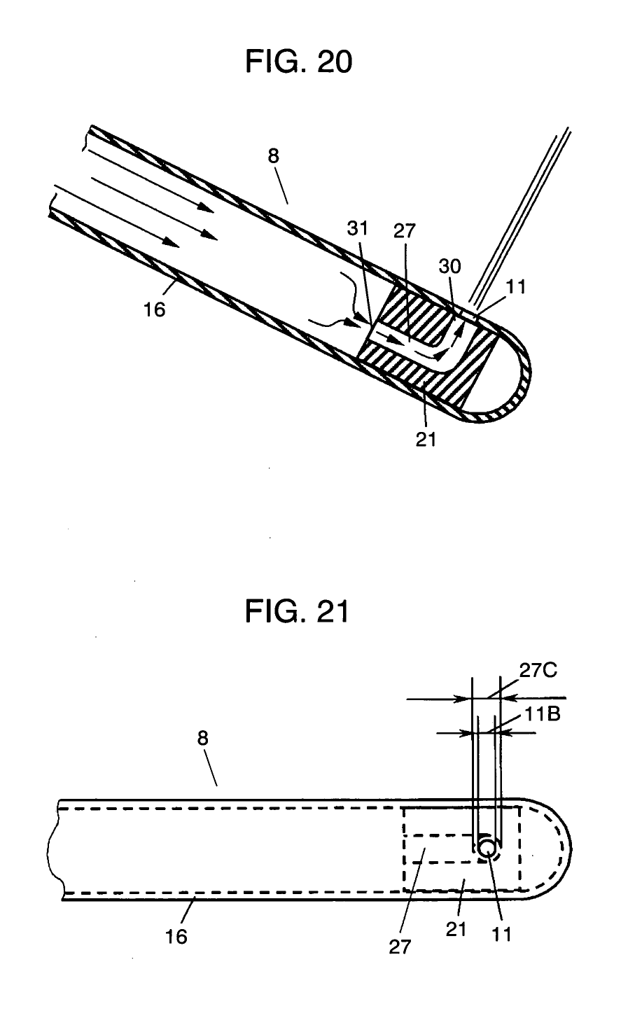

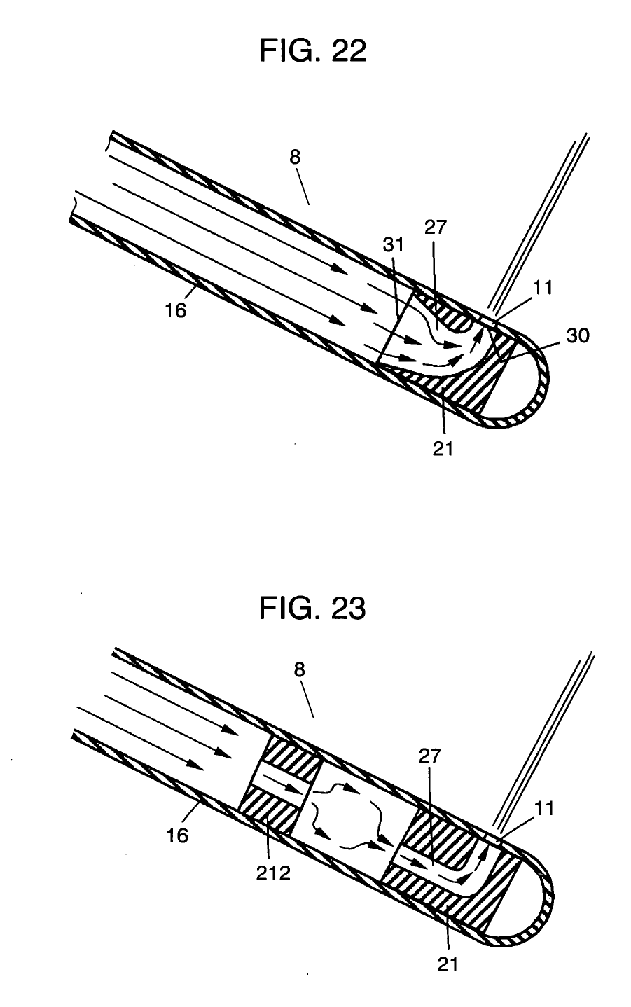

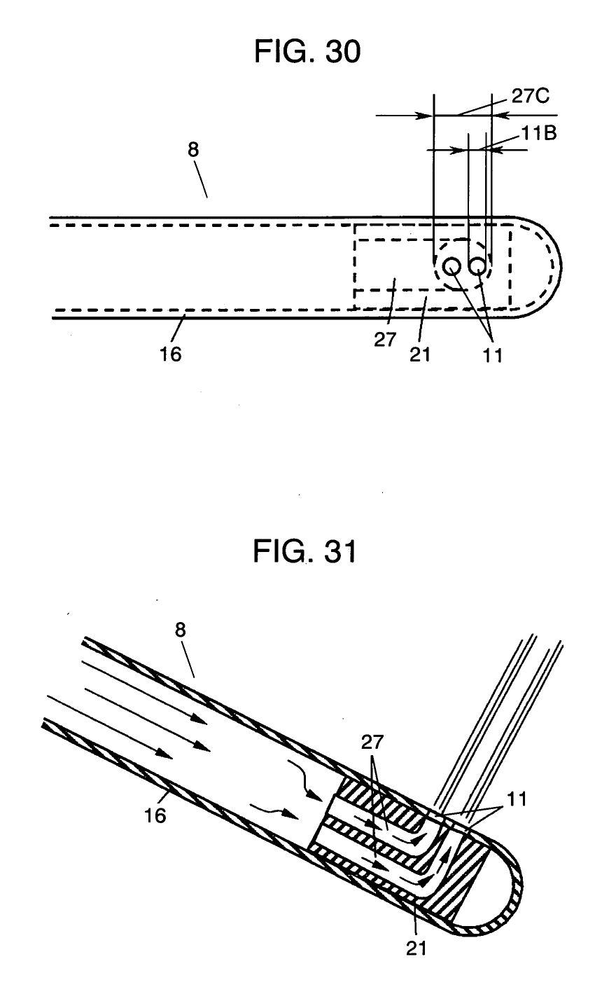

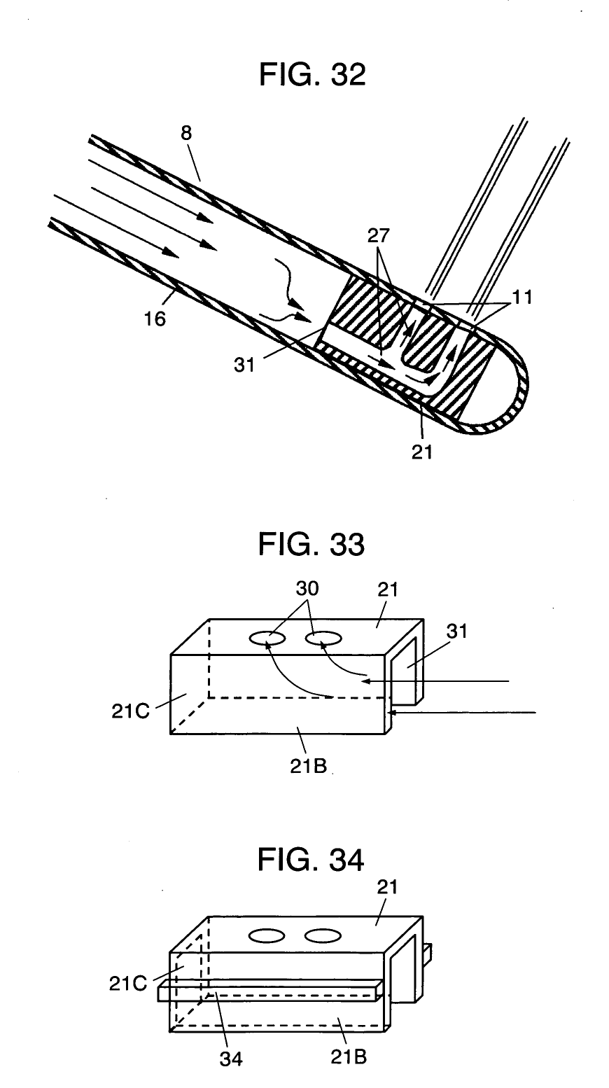

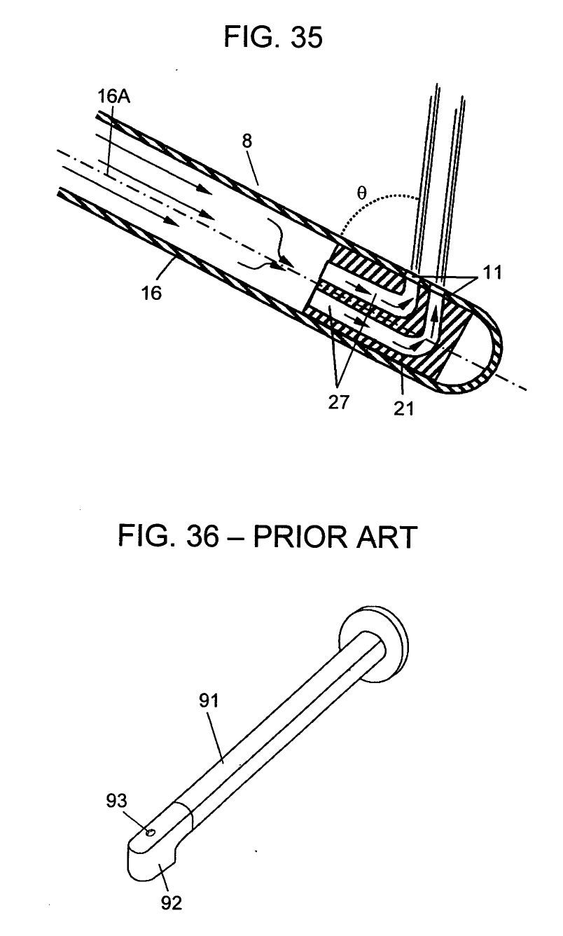

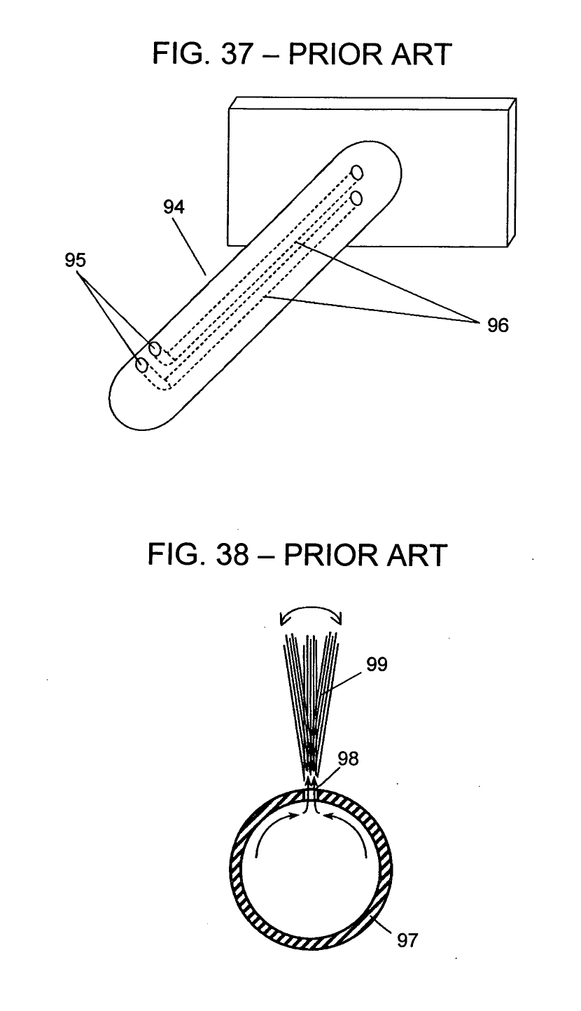

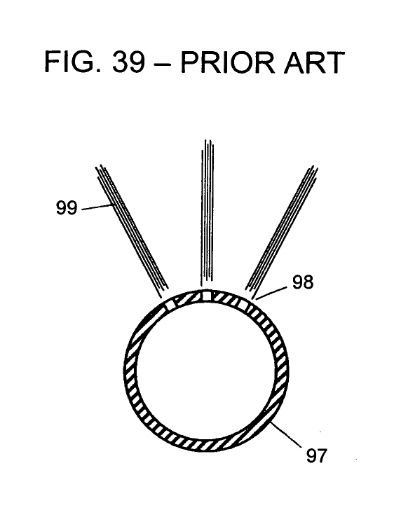

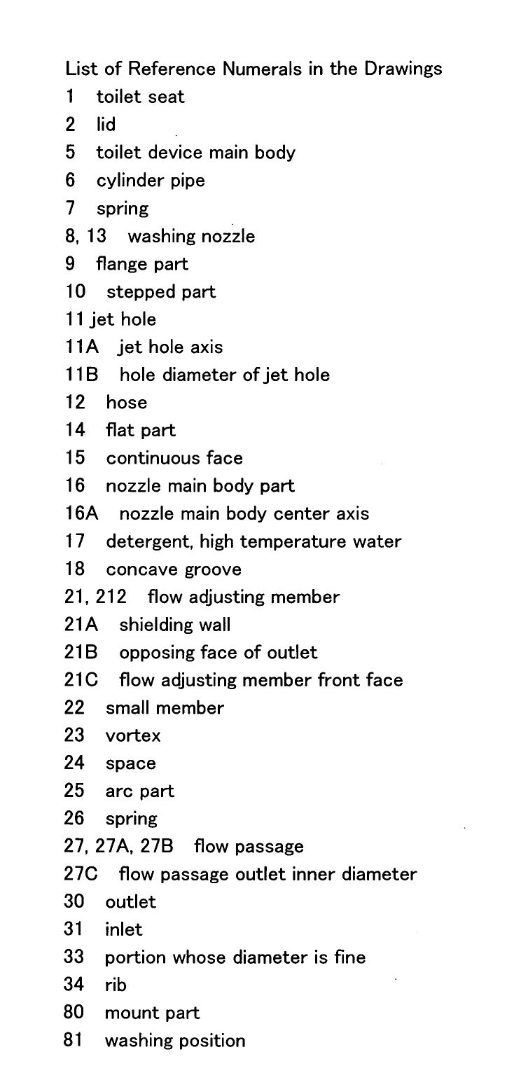

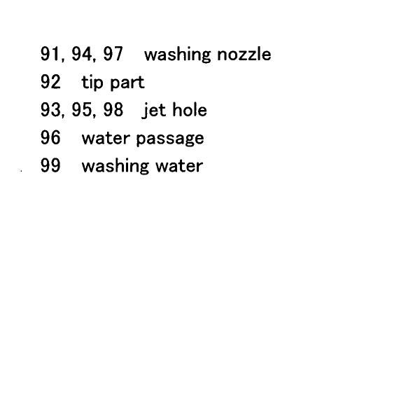

FIG. 10-FIG. 12, FIG. 14-FIG. 19C, FIG. 20, FIG. 22-FIG. 29, FIG. 31, FIG. 32 and FIG. 35 are sectional views respectively showing a washing nozzle according to the second exemplary embodiment of the present invention. FIG. 13 is an exploded perspective view showing the washing nozzle to the second exemplary embodiment of the present invention. FIG. 21 is a top view of the nozzle shown in FIG. 20, and FIG. 30 a top view of the nozzle shown in FIG. 29. In the present embodiment, as to the same constitution and a portion performing the same operation as the first exemplary embodiment, there is applied the same reference numeral, and their detailed explanations are omitted.

Flow adjusting member 21 (and flow adjusting member 212) is inserted into washing nozzle (hereafter, nozzle) 8. The washing water flows in the whole space inside nozzle main body 16 or in the whole space constituted by nozzle main body 16 and flow adjusting member 21 as the flow passage to thereby reach jet hole 11, and jets from jet hole 11. It is desirable that flow adjusting member 21 is provided only near jet hole 11. By this, flow adjusting member 21 becomes small, is easily manufactured, and is easily inserted into, e.g., nozzle main body 16. Contrary, it increases a flow adjusting effect to provide flow adjusting member 21 in approximately the whole region of an inside of nozzle main body 16. In this case, as to flow adjusting member 21, there may be combined plural flow adjusting member parts whose constitutions are different, or there may be combined plural flow adjusting member parts whose constitutions are the same. Instead of the case where there are combined the flow adjusting member parts whose constitutions are the same, it may be monolithically manufactured from the beginning. In any case, the flow adjusting member does not clog jet hole 11.

The jetted washing water reaches private parts of the human body, thereby washing the private parts of the human body. Flow adjusting member 21 reduces a turbulence of the washing water flow in nozzle 8, thereby stabilizing the washing water flow jetting from jet hole 11.

Further, flow adjusting member 21 decreases a content volume of nozzle 8. For this reason, a time for filling the inside of nozzle 8 by the washing water becomes short, so that a washing start is advanced. When starting the washing, similarly to the first exemplary embodiment, after a user performs a washing start operation, nozzle 8 is protruded by a motor or a water pressure. When nozzle 8 reaches a washing start position, the inside of nozzle 8 must be filled with the water. In other words, unless the inside of nozzle 8 is filled with the water, the washing cannot be started. Especially, in a case where nozzle 8 is protruded by utilizing the water pressure, after the nozzle 8 is filled with the water, nozzle 8 begins protruding for the first time. For this reason, an effect of shortening a washing start time by decreasing the content volume inside nozzle 8 by flow adjusting member 21 is very significant.

Further, in the case where nozzle 8 is protruded by utilizing the water pressure, a pressure loss of nozzle 8 is one of important factors influencing a performance. In a case of providing no flow adjusting member 21, since nozzle 8 is made of metal, a complicated machining is difficult. In order to produce nozzle 8 inexpensively and with a good productivity, it is necessary to constitute nozzle 8 in a simple tubular form. For this reason, the pressure loss is determined by a shape of jet hole 11. In a case where the pressure loss is high, a protrusion performance is improved. In other words, the nozzle protrusion in a small flow rate becomes possible, and the protrusion is speedy as well. However, if the pressure loss is too high, contrary the enough flow rate is difficult to be obtained. For this reason, it is important to make the pressure loss well balanced. In the present exemplary embodiment, flow adjusting member 21 is provided inside nozzle main body 16. By changing a shape of flow adjusting member 21, it is possible to freely set the pressure loss.

If flow adjusting member 21 is fixed to nozzle main body 16, the washing water flow is not disturbed by the fact that flow adjusting member 21 moves through the inside of nozzle main body 16. In addition, there is no anxiety of a wear of nozzle main body 16 or flow adjusting member 21, the washing start is advanced, and additionally the washing water flow is stabilized and durability is improved as well. For a fixation between nozzle main body 16 and flow adjusting member 21, there may be used an adhesive, or the latter may be fixed by caulking one part of nozzle main body 16. Further, flow adjusting member 21 may be fixed by pressing it into nozzle main body 16.

Further, for flow adjusting member 21, there may be used a net-like (fiber-like) material whose shape can be freely changed. For example, it suffices if the net-like material is balled up and stuffed into nozzle main body 16. Further, as another method, there may be used a sponge-like foamed body material. In these cases, flow adjusting member 21 is easily fixed by the press fit and, even in a case where the shape of nozzle main body 16 differs, flow adjusting member 21 is made a common use.

In the case where flow adjusting member 21 is not provided in nozzle main body 16, the water is filled in nozzle main body 16. If flow adjusting member 21 is constituted by a material whose specific gravity is lower than water, a weight of nozzle main body 16 is reduced, a protruding speed of nozzle 8 is improved, and the washing start is advanced. Additionally, by the fact that the weight is light, it becomes advantageous also in a durable aspect. In a case where the protrusion of the nozzle is performed by a motor, a motor load is reduced. In a case where a DC motor is used in the motor, it is inexpensive. In a case where a stepping motor is used, a control is easy. In a case where the water pressure is utilized in the protrusion of the nozzle, a friction of a slide part is reduced.

In a case where a foamed material is used in flow adjusting member 21, it is very light, so the washing start is advanced, and additionally it is advantageous also in the durable aspect. In a case where a resin is used in flow adjusting member 21, it can be machined even if it is a complicated shape, and adjustments of the flow adjusting effect and the pressure loss are easy.

Most of the toilet devices have two of nozzle 8 for a hip washing and nozzle 13 for a female private parts washing, and structures of these nozzles differ as well. By providing different flow adjusting members 21, it is also possible to jointly use one nozzle main body 16 either for the hip washing or for the female private parts washing.

Similarly to the first exemplary embodiment, nozzle main body 16 is formed in one body including the tip by the deep drawing of the metal. For this reason, there is no joint in the tip unlike the conventional nozzle, so that the crud is difficult to adhere. Further, since flow adjusting member 21 does not clog jet hole 11, there are no such step of exterior view of jet hole 11, interstice and joint that the contamination adheres thereto. For this reason, nozzle 8 is maintained cleanly, and an influence of a positional dispersion in assembling is reduced as well.

Hereinafter, various examples of the flow adjusting member are explained.

In a constitution shown in FIG. 10, flow adjusting member 21 is disposed at a position opposite to jet hole 11 provided in the nozzle tip, thereby decreasing the content volume within nozzle 8. By this constitution, a water flow near the tip becomes speedy, and the washing water flow jetting from jet hole 11 is stabilized.

In a constitution shown in FIG. 11, flow adjusting member 21 is provided in one part of the flow passage or the whole of the flow passage inside nozzle main body 16. By this, there are obtained an operation, an action and an effect, which are similar to the above constitution.

As to flow adjusting member 21, it suffices if there is selected a constitution for obtaining a necessary water flow, such as a member constituted by a porous body or a member having plural fine water passages. In a case where flow adjusting member 21 constitutes one part of the flow passage, an assembling property is improved. In a case where it constitutes the whole of the flow passage, the flow adjusting effect is more increased.

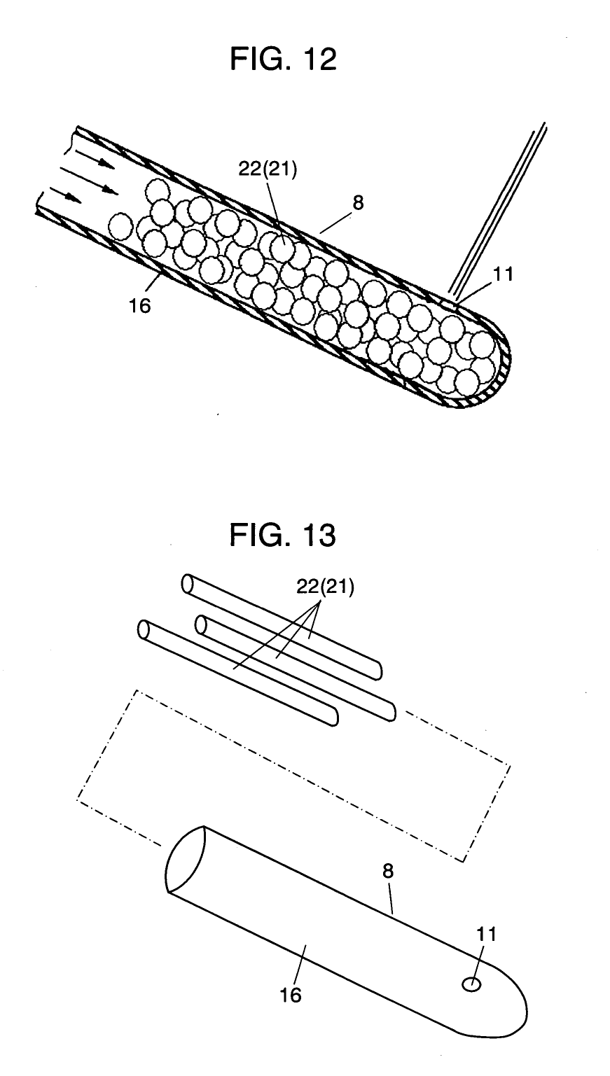

In a constitution shown in FIG. 12, flow adjusting member 21 inside nozzle main body 16 is constituted by plural small members 22, and they are filled inside nozzle main body 16.

Most of the toilet devices have two of nozzle 8 for the hip washing and nozzle 13 for the female private parts washing, and the wash feeling demanded for each of the nozzles is different as well. Since an object of the hip washing is to certainly remove the filth, there is demanded the wash feeling which is strong in a certain degree. On the other hand, in the female private parts washing, softness is necessary. From the fact that the demanded wash feelings are different, structures of both nozzles are different. However, by constituting flow adjusting member 21 with different small members 22, it is possible to jointly use nozzle main body 16.

Since small member 22 is larger than jet hole 11, it does not fly out of jet hole 11. In order to ensure a stable performance, it is desirable that small members 22 have the same shape. In a case where small member 22 is made a ball, machining is easy, and a filling ratio is more increased. In a case where they are filled most densely, a void ratio becomes 74%.

In a constitution shown in an exploded perspective view of FIG. 13, plural cylindrical small members 22 are inserted in the same direction. Also in this case, machining is easy, and the void ratio at this time becomes 90%.

Although not shown in the drawing, if small members 22 are filled in nozzle main body 16 and a rear end part of nozzle main body 16 is plugged while ensuring the flow passages, flows of small members 22 are fixed or restricted.

In a constitution shown in FIG. 14, flow adjusting member 21 is provided closer to tip than jet hole 11 of nozzle 8, and additionally shielding wall (hereafter, wall) 21A is disposed in the vicinity of jet hole 11. FIG. 14 is a sectional view including jet hole axis (hereafter, axis) 11A and nozzle main body center axis (hereafter, axis) 16A. In a case where flow adjusting member 21 is not inserted, the water flow collides against a tip part of nozzle 8, so that the flow becomes complicated. On the other hand, as shown in FIG. 14, by constituting wall 21A by flow adjusting member 21, the water does not flow to the tip part of nozzle 8. By this, a generation of a vortex of the washing water flow is suppressed, so that the turbulence is reduced. Here, “the vicinity of jet hole 11” means the fact that a distance between axis 11A and wall 21A is two times or less of hole diameter 11B of jet hole 11.

As shown in FIG. 3B, the position of private parts when seated on toilet seat 1 is significantly affected by the shape of main body 5 and the shape of toilet seat 1, so that it is necessary to set the position in which the washing water is applied to the private parts according to the shapes. Since it is necessary that nozzle 8 is accommodated into main body 5 at its non-washing time, there is a limit in a length of nozzle 8. Especially, in a case of designing washing position 81 forward, it is possible to move washing position 81 forward by changing a jet angle of the washing water flow. Further, the wash feeling is affected also by an angle of the washing and, if an angle at which it is applied to the private parts is made large, the wash feeling is sensed strongly. In a case where the angle is small, the filth is difficult to adhere to nozzle 8. In other words, the washing angle affects the washing position, the wash feeling and an easiness of being contaminated.

However, in a case where nozzle 8 is thin-walled one, the jet angle of the washing water flow becomes approximately perpendicular to nozzle main body 16, so that an adjustment of the jet angle of nozzle 8 is difficult. In other words, for the adjustment of the jet angle, adjustments of angles of cylinder pipe 6 and/or mount part 80 is necessary. However, it is very difficult to change the angles within a limited space inside the main body 5.

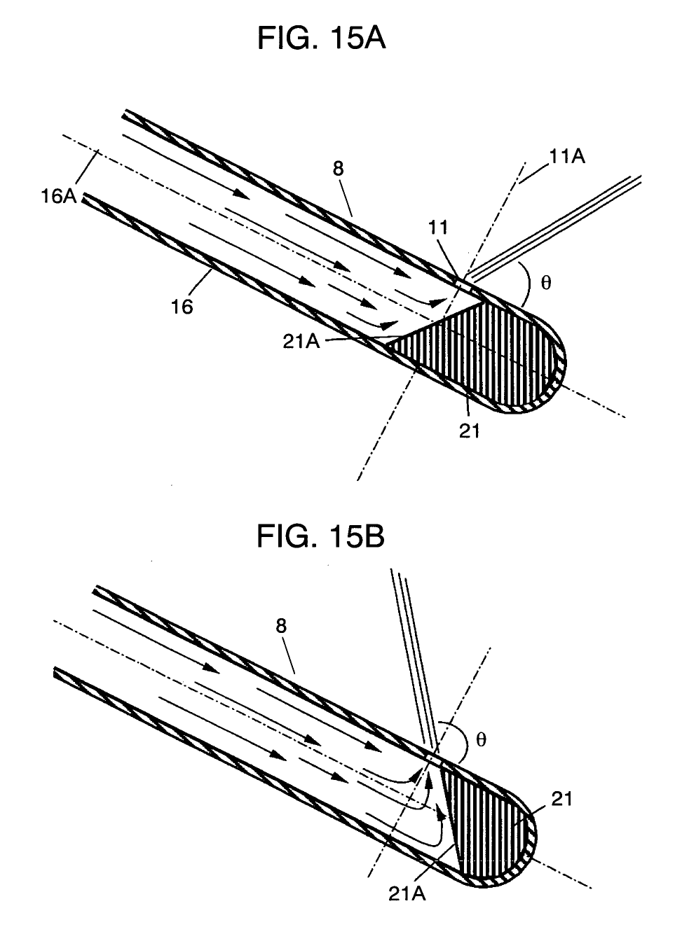

Here, as shown in FIG. 15A, flow adjusting member 21 is inserted into nozzle main body 16, thereby causing wall 21A to have a predetermined angle θ with respect to axis 11A. By this, even in a case where main body 5 or toilet seat 1 differs and thus washing position 81 differs, desired washing position 81 can be provided by exchanging only flow adjusting member 21. FIG. 15A shows an example in which θ is smaller than a right angle. Besides, θ can be made larger than the right angle as shown in FIG. 15B. In this arrangement, the washing water can achieve to private parts at a large angle, so that the wash feeling becomes strong.

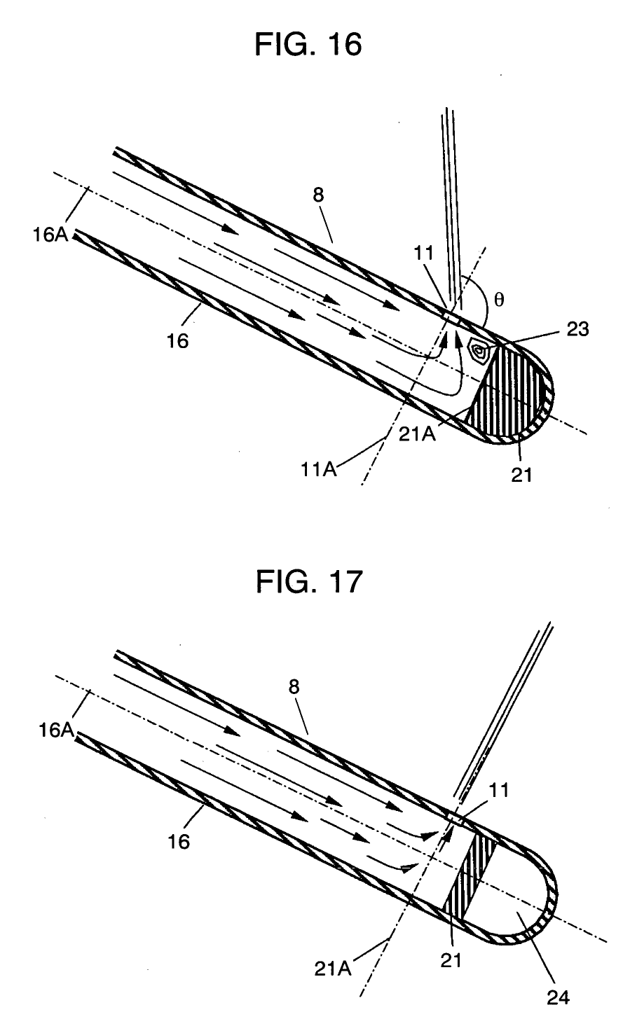

In a constitution shown in FIG. 16, flow adjusting member 21 is provided closer to the tip part than jet hole 11, and additionally wall 21A is disposed in a position spaced by a certain distance from jet hole 11 or more. Here, “spaced by the certain distance” means the fact that the distance between axis 11A and wall 21A is two times hole diameter 11B of jet hole 11. In this configuration, the washing water flowing inside nozzle main body 16 collides against wall 21A, reaches jet hole 11 after being repelled, and jets. At this time, vortex 23 is generated between wall 21A and jet hole 11. By vortex 23, the washing water reaching jet hole 11 jets at the jet angle θ. Since the jet angle θ is larger than 90°, an angle at which the washing water is applied to the private parts becomes large.

As mentioned before, the washing angle is an important factor affecting the wash feeling, the washing position and the easiness of being contaminated. As shown in FIG. 16, only by providing flow adjusting member 21 whose shape is very simple inside nozzle main body 16, the jet angle θ can be made 90° or more.

Flow adjusting member 21 mentioned above has a constitution preventing an inflow of the washing water into nozzle 8 tip, so it may fill the whole of the tip of nozzle 8 as shown in FIG. 14-FIG. 16, or may have a space 24 as shown in FIG. 17. Shapes of these flow adjusting members 21 are very simple, they can be manufactured easily, and they can be assembled simply as well.

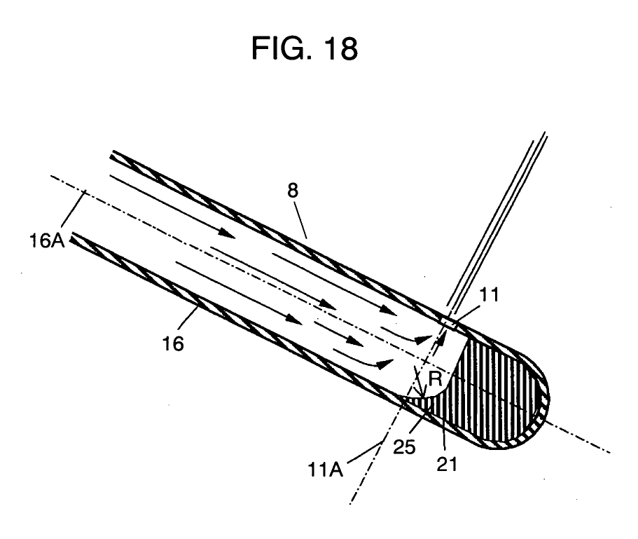

Further, as shown in FIG. 18, by providing arc part 25 in a tangential line part between nozzle main body 16 and flow adjusting member 21 to thereby be made like a slope, the turbulence of the washing water is reduces, and the flow of the washing water is more stabilized.

Further, as mentioned before, by moving the position of flow adjusting member 21 with respect to wall 21A in an axial direction of nozzle main body 16, the jet angle of the washing water changes. In other words, constituting wall 21A such that the position thereof changes, the washing angle changes. Thus, the area of the private parts to which water reaches becomes wide, and a volume feeling of the washing is increased.

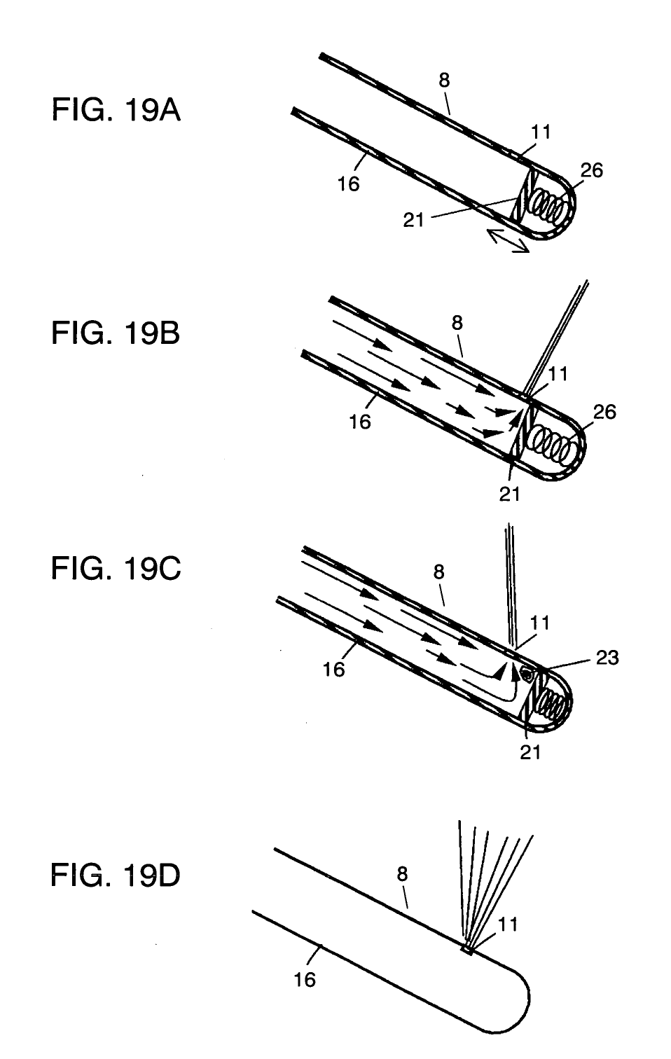

For example, as shown in FIG. 19A, spring 26 is inserted into the tip of nozzle 8, thereby moving flow adjusting member 21 in a direction of axis 16A. By this, when there is no vortex 23 as in FIG. 19B by a balance between vortex 23 and spring 26, the jet angle θ becomes small. As shown in FIG. 19C, when vortex 23 is generated, the jet angle θ of the washing water becomes large. As a result, as shown in a perspective view of FIG. 19D, the area of the private parts to which water reaches becomes wide.

Further, generally, since nozzle 8 is slantingly disposed as shown in FIG. 3B, the water in a part lower than jet hole 11 does not fall out also when the washing ends and nozzle 8 is accommodated into main body 5. This residual water is cooled before a next washing start, and it follows that this cooled water reaches the private parts at a washing start time, so that an unwell feeling is given to the user. On the other hand, by adopting flow adjusting member 21 as shown in FIG. 14-FIG. 19A, the residual water in the tip part of nozzle main body 16 is reduced, so that the wash feeling is improved.

In a constitution shown in FIG. 20, flow adjusting member 21 is internally mounted to nozzle main body 16 and in its inside, it has L-shaped flow passage 27. The washing water is flow-adjusted by passing therethrough. Inlet 31 of flow passage 27 communicates with an upstream side within nozzle main body 16, and outlet 30 is directly connected to jet hole 11. FIG. 21 is a top view of nozzle 8. In flow adjusting member 21, inner diameter 27C of flow passage 27 from inlet 31 to outlet 30 is equal, and inner diameter 27C is larger than hole diameter 11B of jet hole 11.

The washing water flows in the whole of a space inside nozzle main body 16 as a flow passage to thereby reach flow adjusting member 21, directly reaches jet hole 11 from outlet 30 while passing through flow passage 27 from inlet 31, and jets from jet hole 11. The jetting washing water reaches private parts of the human body, thereby washing the private parts of the human body. The washing water initially flows in the whole of the space inside nozzle main body 16 as a flow passage, and it is throttled when it reaches flow passage 27 of flow adjusting member 21, and flow-adjusted by flow passage 27. For this reason, when it reaches jet hole 11, a stable flow is obtained.

Accordingly, the washing water jetting from jet hole 11 is stabilized in its jet state and jet direction, and the water reaching area when the washing water is applied to the private parts of the human body that is an object to be washed becomes optimum. Especially, it is effective for a bidet washing in which the washing water is jetted from plural jet holes 11. That is, in FIG. 20, as to jet hole 11, although there is shown one, even if plural jet holes 11 are provided as a bidet washing nozzle for instance, there is obtained a similar effect. In other words, the jet direction of the washing water is stabilized, and there are obtained parallel flows necessary for bidet washing water flows. In this case, there may be provided plural jet holes 11 for one flow passage provided in flow adjusting member 21, or there may be provided plural flow passages respectively corresponding to plural jet holes 11. About this, it is mentioned later.

Inner diameter 27C of the outlet of flow passage 27 in flow adjusting member 21 is larger than hole diameter 11B of jet hole 11. For this reason, in exterior view, there is no step such as interstice and joint to which the crud adheres. For this reason, nozzle 8 is maintained cleanly, and the influence of the positional dispersion at assembling is reduced as well.

In FIG. 20, there is shown such that flow adjusting member 21 has flow passage 27 communicating to jet hole 11 and outlet 30 of flow passage 27 mutually overlaps with jet hole 11. Other than this, there may be selected a form having a flow adjusting action, e.g., a constitution for obtaining the necessary water flow, such as flow adjusting member constituted by a porous body or flow adjusting member having plural fine flow passages.

In a constitution shown in FIG. 22, flow adjusting member 21 internally mounted to nozzle main body 16 has L-shaped flow passage 27 in its inside. The washing water is flow-adjusted by passing therethrough. Inlet 31 of flow passage 27 communicates with the upstream side within nozzle main body 16, and outlet 30 is directly connected to jet hole 11. Inlet 31 of flow passage 27 is slightly smaller than an inner diameter of nozzle main body 16. An inner diameter of outlet 30 of flow passage 27 is smaller than inlet 31, and somewhat larger than an inner diameter of jet hole 11. Additionally, an inner diameter of flow passage 27 becomes gradually small from inlet 31 side to outlet 30 side.

The washing water flows in the whole of the space inside nozzle main body 16 being as a flow passage to thereby reach flow adjusting member 21, enters from inlet 31 into flow passage 27, flows through flow passage 27, and flows out of outlet 30. The inner diameter of flow passage 27 becomes smaller in a manner that the inner diameter is gradually throttled from inlet 31 side to outlet 30 side. For this reason, a sudden change in the water flow (sudden reduction in the flow passage) does not occur during the washing water flows through flow passage 27, so that it jets from outlet 30 while passing through jet hole 11 under a very stable state. Accordingly, the washing water jetting from jet hole 11 is stabilized in its jet state and jet direction.

Further, as shown in FIG. 21 and FIG. 22, in the case where flow passage 27 is constituted with flow adjusting member 21 being provided near jet hole 11, there is obtained the stable water flow having the rectilinear propagation property. Especially, since nozzle 8 is made of metal and its wall thickness is thin, the rectilinear propagation property is bad and the water flow is difficult to stabilize. The air is mixed inside nozzle main body 16, and there is a phenomenon in which the air irregularly comes out of jet hole 11. On this occasion, if the wall thickness is thin, the water flow significantly fluctuates, so that the unwell feeling is given to the user. It is noticeable in a case where a machining method of nozzle main body 16 is the deep drawing. Further, in the case where it is thin in the wall thickness, in order to cause the water flow to have the rectilinear propagation property, a face around jet hole 11 must be flat, so that it is necessary to make a flat part. Additionally, the water flow is jetted from the flat face only perpendicularly thereto, so that the washing position and the jet angle cannot be freely changed. However, as shown in FIG. 21 and FIG. 22, by providing flow adjusting member 21 near jet hole 11, the water flow is stabilized, and additionally it is possible to determine the washing position and angle by a design of flow adjusting member 21.

Further, as shown in FIG. 23, in addition to flow adjusting member 21 provided near jet hole 11, by providing flow adjusting member 212 in a center part of nozzle main body 16 that is the upstream side of the flow passage in nozzle main body 16, the water pressure is gradually applied. For this reason, the water flow applied to flow adjusting member 21 is flow-adjusted, so that stability more increases.

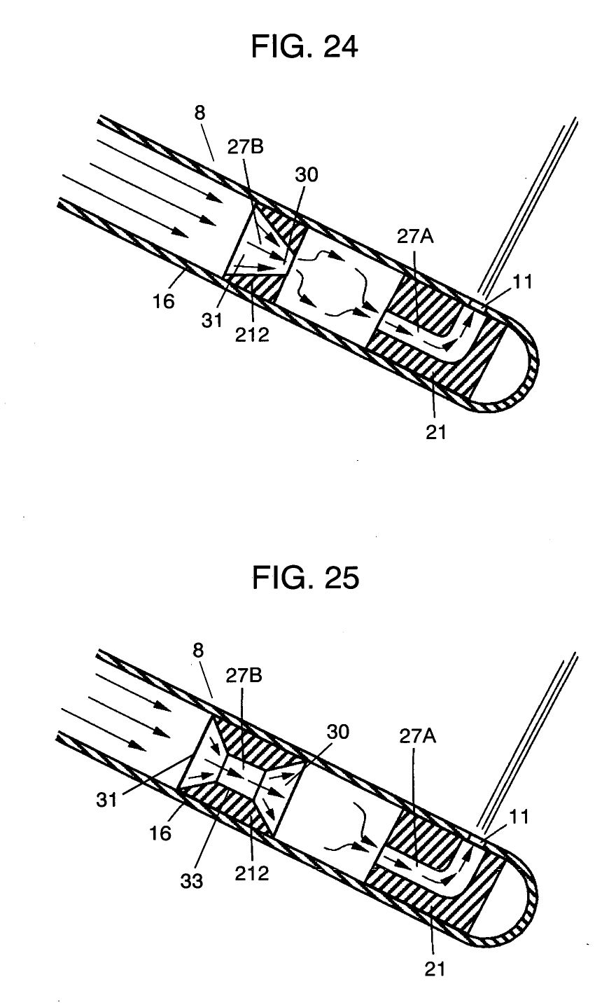

In a structure shown in FIG. 24 as similar to the structure of FIG. 23, outlet 30 of flow passage 27B in flow adjusting member 212 is smaller than inlet 31, and an inner diameter of flow passage 27B is gradually large from inlet 31 to outlet 30. The washing water reaches flow adjusting member 212 in the whole of the space inside nozzle main body 16 as a flow passage, and proceeds from inlet 31 to outlet 30. Here, since flow passage 27B is gradually small, the sudden change in the water flow (sudden reduction in the flow passage) does not occur, so that it jets from jet hole 11 passing through outlet 30 under the very stable state. Therefore, the jetting washing water is stabilized in its jet state and jet direction.

Further, by using a rubber member as flow adjusting member 212, an interstice between it and the inner diameter of nozzle main body 16 becomes null due to its flexibility. And the stability of the water flow more is increased because it passes through only flow passage 27B.

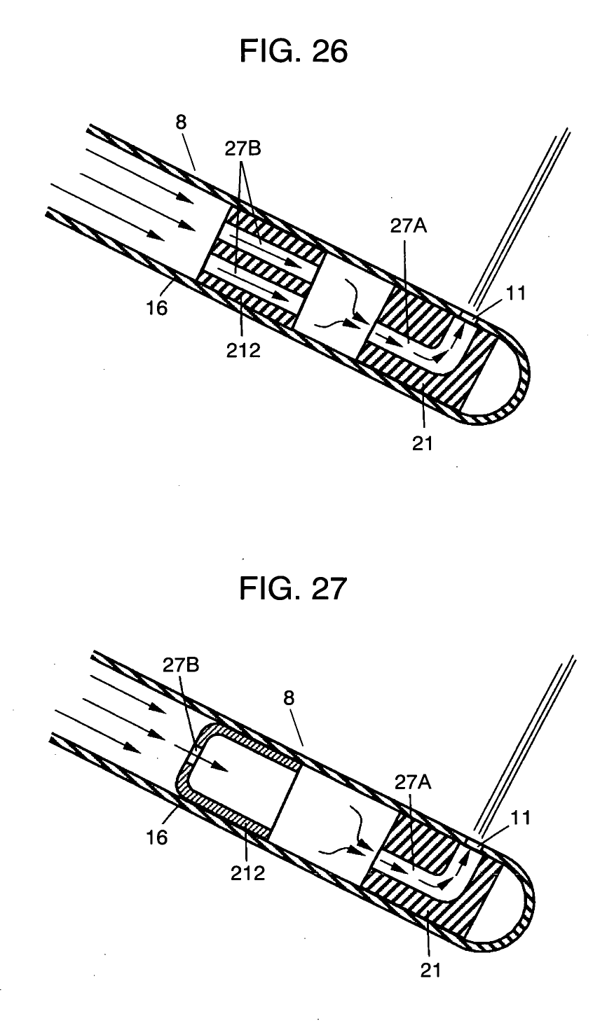

In structures shown in FIG. 25 and FIG. 26 as similar to the structure of FIG. 23, each of flow adjusting members 212 has a complicated shape. That is, in FIG. 25, inlet 31 and outlet 30 have an approximately equal diameter and, in its midway, there is portion 33 whose diameter is smaller than the formers. Further, an inner diameter of outlet 30 is larger than an inner diameter of jet hole 11. In FIG. 26, plural flow passages 27B are provided. By these, washing characteristics are subtly adjusted. On this occasion, when flow adjusting members 212 are made as resin members or rubber members, they are easily formed even if they have complicated shapes. Further, if the material of flow adjusting member 212 is a foamed member, independent air layers are provided, the shape is easily formed, and the washing characteristics are stabilized. A material of the foamed member may be resin-made or rubber-made in compliance with a use and an action.

In a structure shown in FIG. 27 as similar structure to the structure of FIG. 23, flow adjusting member 212 is constituted with a metal-pressed member. By constituting flow adjusting member 212 with such a material, notwithstanding its inexpensiveness, an accuracy of the shape of flow passage 27B is improved and washing characteristics are stabilized.

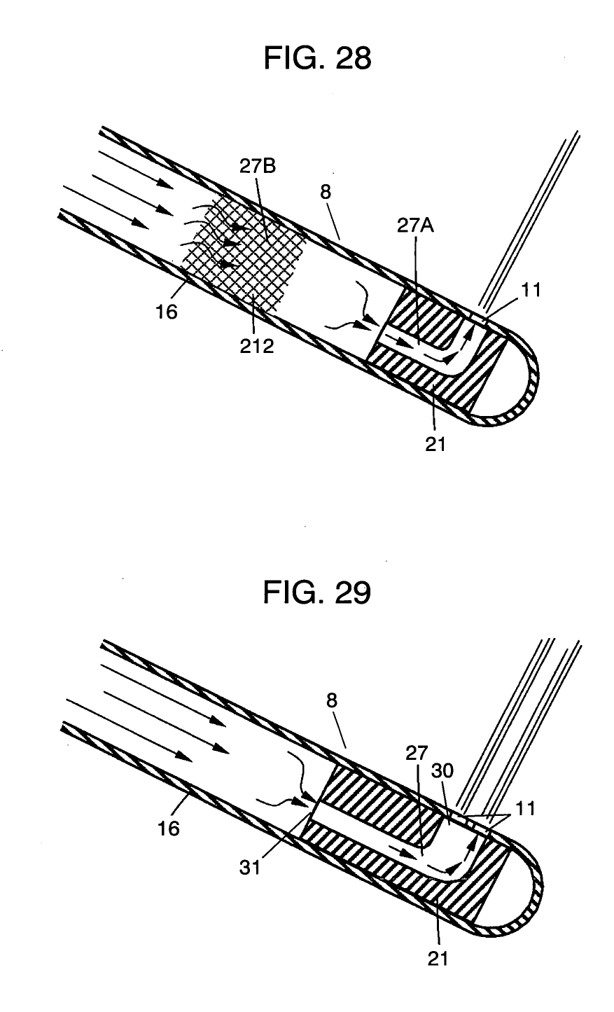

In a structure shown in FIG. 28 as similar structure to the structure of FIG. 23, flow adjusting member 212 is constituted by a fiber member. By constituting flow adjusting member 212 by such a material, even if an inner diameter shape of nozzle main body 16 is complicated, flow adjusting member 212 is easily inserted because its shape fits. Characteristics of flow passage 27B are set according to a density of the fiber member, and the washing characteristics are stabilized. A material of the fiber member may be resin or metal in compliance with the use and the action.

In a constitution shown in FIG. 29, flow adjusting member 21 internally mounted to nozzle 8 has L-shaped flow passage 27 in its inside. The washing water is flow-adjusted bypassing therethrough. Inlet 31 of flow passage 27 communicates with the upstream side within nozzle main body 16, and outlet 30 is directly connected to jet holes 11. FIG. 30 is a top view of the nozzle shown in FIG. 29. Inner diameter 27C in an outlet side of flow passage 27 is larger than hole diameter 11B of jet hole 11. In the constitution shown in FIG. 20, jet hole 11 is one. In regard to this, in the constitution shown in FIG. 29, plural jet holes 11 are provided (here, two), and inner diameter 27C in the outlet side of flow passage 27 is larger than an area of a region in which plural jet holes 11 are provided.

The washing water flows in the whole of the space inside nozzle main body 16 as a flow passage to thereby reach flow adjusting member 21, directly reaches jet holes 11 from outlet 30 while passing through flow passage 27 from inlet 31, and jets from jet holes 11. The jetting washing water reaches private parts of the human body, thereby washing the private parts of the human body. The washing water initially flows in the whole of the space inside nozzle main body 16 as a flow passage, and it is throttled if it reaches flow passage 27 of flow adjusting member 21, and flow-adjusted by flow passage 27. For this reason, when it reaches jet holes 11, it becomes the stable flow. Further, inner diameter 27C of outlet 30 of flow passage 27 is larger than hole diameter 11B of jet hole 11. For this reason, in the exterior view of jet hole 11, there is no step, such as the interstice and the joint to which the crud adheres, so that it is maintained cleanly, and the influence of the positional dispersion at assembling is reduced as well.

Like a constitution shown in FIG. 31, in a case where there are formed plural flow passages 27 communicating with plural jet holes 11 correspondingly thereto, the flow adjusting effect is increased. Especially, it is effective in a case where parallel flows are necessary like the bidet washing.

In a constitution shown in FIG. 32, flow adjusting member 21 has one inlet 31 into which the washing water flows, and there are formed plural flow passages 27 causing inlet 31 to communicate with jet holes 11 provided in nozzle 8. In this constitution, the flow adjusting effect is increased, and flow adjusting member 21 is easily manufactured.

FIG. 33 and FIG. 34 are perspective views showing flow adjusting member 21 in FIG. 29. In flow adjusting member 21 shown in FIG. 33, inlet 31 and opposed face 21B of outlet 30 are opened. By this, the washing water flow is stabilized, and flow adjusting member 21 is easily manufactured. Additionally, since a face with which flow adjusting member 21 contacts when it is inserted into nozzle main body 16 is small, an assembling work becomes easy.

Further, as shown in FIG. 34, it may be a shape in which flow adjusting member front face 21C opposite to inlet 31 is opened. As shown in FIG. 33, in a case where a wall is provided in front face 21C, it is easy to fix a position when flow adjusting member 21 is inserted into nozzle main body 16. In the case where front face 21C is opened, flow adjusting member 21 is manufactured more easily.

Flow adjusting members 21 mentioned above may be pressure-inserted, or an adhesive may be used, when fixed to nozzle main body 16. Otherwise, after inserting flow adjusting member 21 into nozzle main body 16, it may be fixed by such means as to caulk the nozzle main body 16 from the outside. In the case of pressure-inserting, by erecting rib 34 on flow adjusting member 21 as shown in FIG. 34, an insertion work becomes easy by pressure-inserting only rib 34 not the whole faces.

In a constitution shown in FIG. 35, flow adjusting member 21 inserted into nozzle main body 16 has flow passage 27 possessing an arbitrary angle θ with respect to a face on which jet holes 11 are provided. That is, an axis in the outlet side of flow passage 27 and nozzle main body center axis 16A form the angle θ. By this, a washing water jet angle is adjusted. For this reason, there is brought about the effect similar to the constitution shown in FIG. 15A, FIG. 15B or FIG. 16.

Further, the longer the flow passage 27 of flow adjusting member 21 is, the more the flow adjusting effect is increased. Especially, the longer a length coincident with the axis of the washing water jetting from jet hole 11 is, more preferable it is. As shown in FIG. 32, in the case where inlet 31 into which the washing water flows is one and there are formed plural flow passages causing inlet 31 to communicate with jet holes 11, the flow adjusting effect on each jet hole 11 becomes equivalent. Further, as shown in FIG. 33, if inlet 31 and face 21B opposing to outlets 30 in flow adjusting member 21 are opened, the length coincident with the axis of the washing water becomes long, so that the flow adjusting effect is increased.

In FIG. 33-FIG. 35, it is shown and explained centering on the case where plural jet holes 11 are provided. Even if jet hole 11 is one, it can be performed similarly.

In each of the constitutions shown in Fifg. 20-FIG. 35, although flow adjusting member 21 is provided inside nozzle 8 while being directly connected to jet hole(s) 11, it is not limited to this. Within a scope capable of achieving a desired object, flow adjusting member 21 may be provided in a midway, of nozzle 8, leading to jet hole 11 for instance.

In the present exemplary embodiment, nozzle main body 16 is manufactured by deep-drawing the thin-walled metal. For this reason, nozzle main body 16 is inexpensive. On the other hand, nozzle main body 16 may be manufactured by cutting a metal-made pipe and getting a lid as a separate component on its tip part. If the lid is joined by a welding, there is no interstice and a seamless structure can be obtained. In a case where the lid is fitted by a pressure insertion, some groove occurs. However, since it is made of metal, disinfection at high temperatures is possible, so that nozzle main body 16 is kept clean.

As explained in the first exemplary embodiment, in the case where flat part 14 is provided on nozzle 8 and jet hole 11 is provided on flat part 14, the inner volume of nozzle main body 16 is partially decreased by flat part 14. Accordingly, by constituting flat part 14, a portion protruding to the inside of nozzle 8 brings about also an effect similar to flow adjusting member 21 in the second exemplary embodiment.

Further, it makes the jet characteristics of the washing water more improved to additionally, internally mount flow adjusting member 21 explained in the second exemplary embodiment to the constitution explained in the first exemplary embodiment.

### INDUSTRIAL APPLICABILITY

According to the present invention, a toilet device is obtained, which has a clean washing nozzle with no washing restriction and hard to splotch, and whose washing characteristics are improved as well.

1. A washing nozzle comprising:
a bottomed tubular main body provided with a jet hole for jetting washing water at a tip thereof, and
at least any of
a flat part provided at least at the tip of the main body and monolithically joined together to the main body by a continuous face, and
a flow adjusting member provided inside the main body and adjusting a flow of the washing water.

2. The washing nozzle according to claim 1,
wherein the main body comprises a metal material with thickness of at least 0.2 mm and at most 0.8 mm.

3. The washing nozzle according to claim 2,
wherein the flat part comprises the metal material with thickness of at least 0.2 mm and at most 0.8 mm.

4. The washing nozzle according to claim 1,
wherein the flat part is provided over a whole length of the main body.

5. The washing nozzle according to claim 1,
wherein a section of the main body is a circular shape.

6. The washing nozzle according to claim 1,
wherein a section of the main body is a polygonal shape.

7. The washing nozzle according to claim 1,
wherein the main body comprises stainless steel.

8. The washing nozzle according to claim 7,
wherein the flat part comprises stainless steel.

9. The washing nozzle according to claim 1,
wherein a concave groove is provided along a longitudinal direction thereof the concave groove for leading a liquid washing the main body to the jet hole.

10. The washing nozzle according to claim 1,
wherein the jet hole is one of plural jet holes, the plural jet holes are provided in the flat part, the plural jet holes for jetting the washing water in parallel.

11. The washing nozzle according to claim 1,
wherein the flow adjusting member is provided while contacting with the jet hole.

12. The washing nozzle according to claim 1,
wherein the flow adjusting member is provided over a whole region of the main body.

13. The washing nozzle according to claim 1,
wherein the flow adjusting member is fixed to the main body.

14. The washing nozzle according to claim 1,
wherein the flow adjusting member comprises any of a net-like body and a foamed body.

15. The washing nozzle according to claim 1,
wherein the flow adjusting member is lighter than water in specific gravity.

16. The washing nozzle according to claim 1,
wherein the flow adjusting member is provided opposing to the jet hole.

17. The washing nozzle according to claim 1,
wherein the main body is provided in an inside thereof with a first flow passage of the washing water, and the flow adjusting member is provided in a part of the first flow passage.

18. The washing nozzle according to claim 1,
wherein the flow adjusting member is one of plural members, and the plural flow adjusting members are possessed.

19. The washing nozzle according to claim 18,
wherein the plural flow adjusting members are balls with diameters larger than the jet hole, and filled in the main body.

20. The washing nozzle according to claim 18,
wherein the plural flow adjusting members are cylindrical bodies inserted in the same direction, and filled in the main body.

21. The washing nozzle according to claim 1,
wherein the flow adjusting member is provided in a side of the tip than the jet hole, and has a shielding wall intercepting a flow of the washing water.

22. The washing nozzle according to claim 21,
wherein the shielding wall is provided at an angle other than a right angle with respect to a center axis of the jet hole.

23. The washing nozzle according to claim 21,
wherein the shielding wall is provided in a position in which a distance to a center axis of the jet hole is spaced by at least two times of a hole diameter of the jet hole.

24. The washing nozzle according to claim 21,
wherein a space is provided between the flow adjusting member and the tip of the main body.

25. The washing nozzle according to claim 1,
wherein the flow adjusting member has an arc part in a tangential line part to the main body.

26. The washing nozzle according to claim 21,
wherein the flow adjusting member is movable in an axial direction of the main body.

27. The washing nozzle according to claim 1,
wherein the flow adjusting member is provided in an inside thereof with a second flow passage passing the washing water therethrough, and an outlet of the second flow passage overlaps with the jet hole.

28. The washing nozzle according to claim 27,
wherein an inner diameter of the outlet of the second flow passage is larger than a hole diameter of the jet hole.

29. The washing nozzle according to claim 27,
wherein an inner diameter of an inlet of the second flow passage is larger than an inner diameter of the outlet, and an inner diameter of a whole of the second flow passage is gradually small from the inlet to the outlet.

30. The washing nozzle according to claim 18,
wherein the main body is provided in an inside thereof with a first flow passage of the washing water, and the plural flow adjusting members includes a first member provided in the tip and a second member provided in an upstream side of the first flow passage of the main body.

31. The washing nozzle according to claim 30,
wherein the second member is provided in an inside thereof with a third flow passage, an inner diameter of an inlet of the third flow passage is larger than an inner diameter of an outlet of the third flow passage, and an inner diameter of a whole of the third flow passage is gradually small from the inlet to the outlet.

32. The washing nozzle according to claim 30,
wherein the second member is provided in an inside thereof with a third flow passage, and an outlet of the third flow passage is larger than an inner diameter of the jet hole.

33. The washing nozzle according to claim 30,
wherein the second member comprises a rubber material.

34. The washing nozzle according to claim 30,
wherein the second member comprises a resin material.

35. The washing nozzle according to claim 30,
wherein the second member comprises a metal-pressed material.

36. The washing nozzle according to claim 10,
wherein the flow adjusting member is provided with plural flow passages communicating respectively with the plural jet holes while corresponding thereto.

37. The washing nozzle according to claim 36,
wherein the inlet for the plural flow passages is one.

38. The washing nozzle according to claim 27,
wherein the flow adjusting member is opened in at least any of a face opposing to the outlet and a face opposing to an inlet of the second flow passage.

39. The washing nozzle according to claim 1,
wherein the flow adjusting member has a rib fixing the flow adjusting member to the main body.

40. The washing nozzle according to claim 27,
wherein an outlet side of the second flow passage is provided at an angle other than a right angle with respect to a center axis of the main body.

41. A method of manufacturing a washing nozzle, comprising:
forming a bottomed tubular body by deep-drawing-press-working a thin sheet metal material,
at least any of a step of
forming a flat part in at least a tip of the tubular body and forming a jet hole of washing water in the flat part, and
providing a flow adjusting member inside the tubular body, the flow adjusting member for adjusting a flow of the washing water passing through an inside of the tubular body, and
forming a jet hole on the tubular body.

42. A toilet device comprising:
a toilet device main body mounted on a toilet bowl, and
a washing nozzle having:
a bottomed tubular main body provided with a jet hole for jetting washing water at a tip thereof, and
at least any of
a flat part provided at least at the tip of the main body and monolithically joined together to the main body by a continuous face, and
a flow adjusting member provided inside the main body and adjusting a flow of the washing water.
